(19) United States
(12) Patent Application Publication
(10) Pub. No.: US 2010/0047741 A1
(43) Pub. Date: Feb. 25, 2010

(54) Dental Implant Carrier

(76) Inventors: Walter Blaim, Innsbruck (AT); Helmut Goreis, Innsbruck (AT); Bruno Pregenzer, Mieming (AT); Alfred Konzett, Patsch (AT)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/444,145

(22) PCT Filed: Oct. 4, 2007
(86) PCT No.: PCT/EP2007/008649

§ 371 Date: Apr. 2, 2009

(30) Foreign Application Priority Data
Oct. 5, 2006 (AT) A 1667/2006

(51) Int. Cl. A61C 8/00

(52) U.S. Cl. 433/173

(57) ABSTRACT

The present invention relates to a dental implant carrier for affixing into a hollow space, in particular a predrilled bore, of a bone having a base body insertable into the hollow space and a clamping part with an implant post for the affixing of a dental implant, wherein the base body has laterally projecting expanding parts which are made in resilient form so that the clamping part engages at the base body and so that the base body can be pulled by the clamping part in the direction of the implant post.

The present invention relates to a dental implant carrier for affixing into a hollow space, in particular a predrilled bore, of a bone having a base body insertable into the hollow space and a clamping part with an implant post for the affixing of a dental implant.

Dental implants as fixedly seated dental prostheses combine many benefits with respect to comfort, dental esthetics and functionality: In this respect, the dental implant carrier is inserted into the jawbone and there is then ingrowth of bone and tissue over time. The tooth implant carrier there takes over the function of a natural root of the tooth. The most important requirement for a successful anchoring of an implant carrier is the fixed ingrowth into the bone tissue, which has usually taken place only after some months. The patient is given a provisional dental prosthesis during the ingrowth period. Once the dental implant carrier has firmly grown in, the final dental prosthesis is fitted.

It is the object of the present invention to propose a dental implant carrier of the initially named kind which also enables immediate loading in addition to an improved fit.

This is achieved in accordance with the invention in an advantageous embodiment in that the base body has laterally projecting expanding parts made in resilient form, in that the clamping part engages at the base body and in that the base body can be pulled in the direction of the implant post by the clamping part.

The jawbone is mainly comprised of sponge-like bone tissue, with this bone tissue being covered externally by a compact, solid bone layer. The present invention now makes use of this dense and stable structure of this outer bone layer (substantia compacta corticalis, briefly called the compacta in the following) in that the resiliently formed expanding parts of the base body can be inserted into the prepared bore of the jawbone in one workstep, with the laterally projecting and preferably compressible expanding parts being automatically expanded again in the radial direction after being led through the opening of the compacta into sponge-like bone tissue. The spread-out expanding parts of the base body can subsequently be pulled at the inner side of the stable compacta by the clamping part in the direction of the implant post. Since the final affixing of the dental implant carrier is operative between the outer side and the inner side of the hard outer bone layer, there is also no additional necessity to anchor the base body with the sponge-like bone tissue disposed beneath the compacta by an expanding device customary in accordance with the prior art. Optionally, as required, such additional affixing techniques can also be used.

Provision can be made in accordance with a preferred embodiment of the invention that the base body has at least two regions of different diameter spaced apart from one another in the unloaded state and that the base body is made in spring-elastic form in the region of the largest diameter and the spring load of the base body in the region of its largest diameter preferably acts outwardly radially. It can be of advantage in this respect if the base body preferably acts outwardly radially at least in the region of its largest diameter. It can be of advantage in this respect if the base body is made compressible at least in the region of its largest diameter so that it can be inserted into the hollow space from the outside. In this respect, it is expedient if the base body is made such that it can be introduced together with the clamping part, for example, by a cooperating screw connection, into the bore of the jawbone.

The expanding parts can preferably be chamfered at their upper free end. In this respect, a chamfer toward the interior of the base body can have the result that a larger contact surface toward the compacta is formed on the expansion of the expanding parts. In accordance with an alternative embodiment of the invention, however, a chamfer can also be formed toward the outer side of the base body.

It is particularly advantageous if a cylindrical region adjoins the clamping part above the preferably present conical section in the radially expanded region, said cylindrical region either having laterally projecting blades or, alternatively, a self-cutting thread. A cutting into the jawbone, and here in particular in the region of the compacta, is hereby achieved on the screwing in of the clamping part in the region of the blades or of the self-cutting thread. The upper region of the clamping part is thus made as a cutting tool which enables an improved fit on the screwing in of the implant.

The term “diameter” within the framework of the present invention preferably relates to the diameter of cylindrical shapes; otherwise, the maximum dimension of the respectively used geometrical shape is to be understood by it.

Further details and advantages of the present invention will be explained with reference to the following description of the Figures. There is/are shown therein:

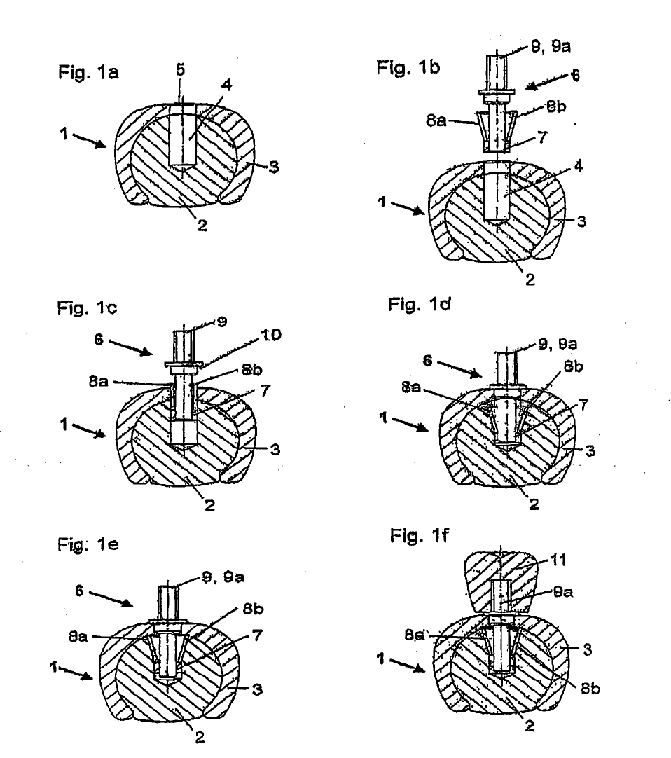

FIGS. 1a to 1f: the enossal installation process of the dental implant carrier in time sequences;

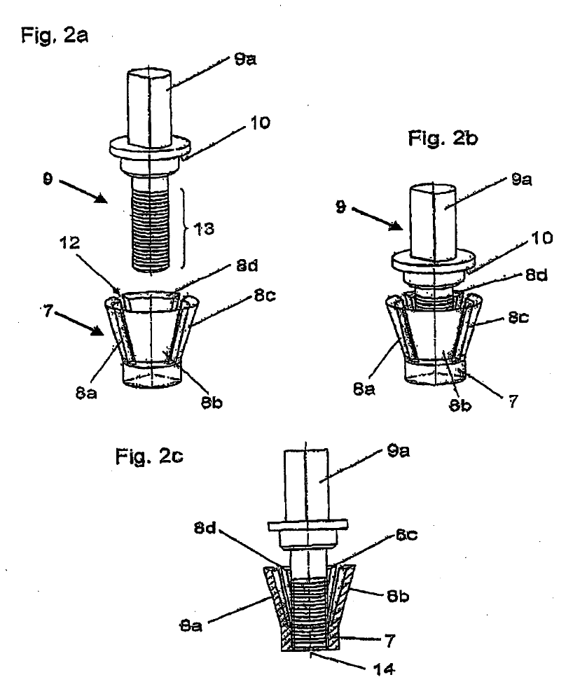

FIGS. 2a to 2c: the dental implant carrier with base body and clamping part;

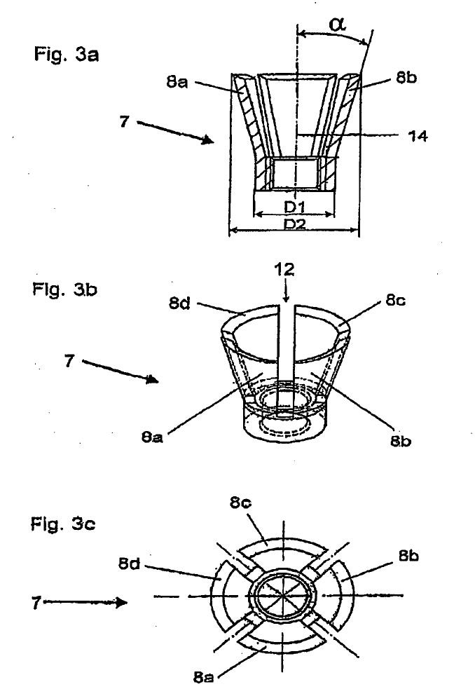

FIGS. 3a to 3c: the base body in different views;

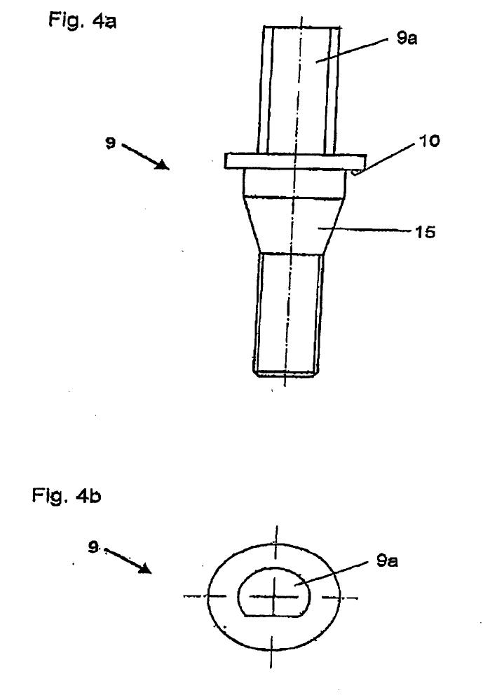

FIGS. 4a and 4b: an alternative embodiment of a clamping part in a front view and a plan view;

FIGS. 5a to 5c: an alternative embodiment of the base body in different views;

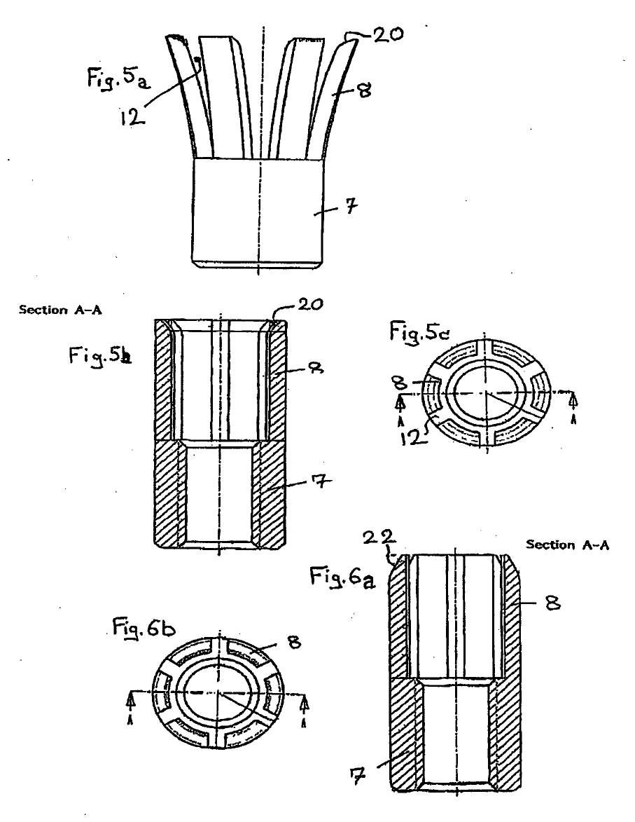

FIGS. 6a and 6b: a further alternative embodiment of the base body in different views;

FIGS. 7a and 7b: a further embodiment of the clamping part in a front view and in a longitudinal section; and

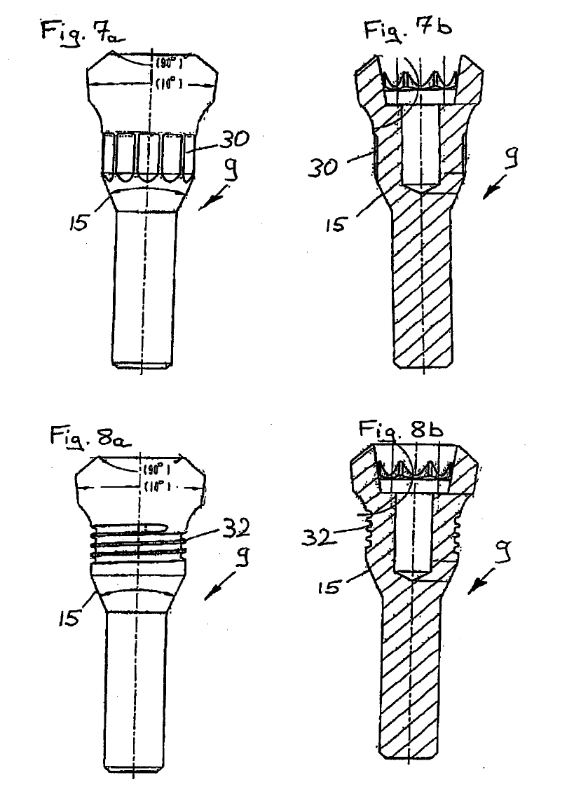

FIGS. 8a and 8b: again, an alternative embodiment of a clamping part in a front view and in a longitudinal section.

FIGS. 1a to 1f show the installation process of the dental implant carrier in time sequences. FIG. 1a schematically shows a vertical section of the jawbone 1 which is mainly made up of sponge-like bone tissue 2 with an outer bone layer 3 of solid structure, the so-called compacta. The compacta 3 forms the outer dense bone plate of the jawbone 1 which is provided as the contact surface for the dental implant carrier in accordance with the invention. In addition, a bore 4 can be seen in FIG. 1a which is drilled into the jawbone 1 in a first workstep. In addition, a flat point 5 is produced whose planar surface serves as a contact surface for the dental implant carrier in the installed state.

FIG. 1b shows the jawbone 1 with the predrilled bore 4 into which a dental implant carrier 6 (shown schematically) in accordance with the invention can be inserted from the outside. The dental implant carrier 6 is made in two parts in the Figure shown and includes a base body 7 with its laterally projecting expanding parts 8a and 8b which are made in spring-elastic form and whose spring force acts radially outwardly under load. The base body 7 with its expanding parts 8a and 8b has a substantially frustoconical outer contour. The expanding parts 8a and 8b are made compressible in the region of their largest diameters. A clamping part 9 is partially screwed into the base body 7, with the external thread of the clamping part 9 cooperating with the base body 7 not being shown due to the purely schematic representation. The clamping part 9 has an implant post 9a for the affixing of an artificial dental prosthesis.

FIG. 1c shows the dental implant carrier 6 partially introduced into the bore 4, with the spring-elastic expanding parts 8a and 8b being compressed in the passage region of the stable compacta 3. The clamping part 9 has a widened abutment surface 10 of cylindrical shape which, as shown in the following Figures, can be brought into contact with the flat point 5 at the outer side of the compacta 3 shown in FIG. 1a. For this reason, the diameter of the abutment surface 10 of the clamping part 9 is made larger than the diameter of the bore 4.

FIG. 1d shows the dental implant carrier 6 which is completely inserted into the jawbone 1 and whose expanding parts 8a and 8b are again automatically radially expanded due to the spring effect after the passage through the bone layer of the compacta 3. The base body 7 is now completely in the sponge-like bone tissue 2 which permits the automatic expansion of the expanding parts 8a and 8b. The abutment surface 10 shown in FIG. 1c now directly contacts flat point 5 (FIG. 1). The clamping part 9 is now screwed further into the base body 7 in a next workstep by the thread cooperating with the base body 7, whereupon the base body 7 can be pulled in the direction of the implant post 9a in the axial direction of the clamping part 9.

FIG. 1e shows the clamping part 9 completely screwed into the base body 7, with the expanding parts 8a and 8b being pulled toward the inner side of the compacta 3 by the screwing process which has already taken place. The dental implant carrier 6 is now firmly anchored in the jawbone 1.

FIG. 1f shows the analog representation in accordance with FIG. 1e with the difference that a schematically shown dental implant 11 is firmly connected to an implant post 9a by an installation process known in accordance with the prior art. The dental implant 11 shown is only indicated in exemplary fashion; in this respect it can also be a bridge having a plurality of dental implants 11 beside an individual dental prosthetic. The dental implant 11 can be loaded immediately due to the expanding parts 8a and 8b pressed together in the compacta 3 and can additionally grow into the bone tissue 2. The dental implant carrier 6 favorably comprises material such as titanium or titanium alloys. In the dental sector, the use of titanium has already proven itself very well since it has biocompatible properties, i.e. inter alia the ability to enter into a direct connection with the bone tissue.

FIG. 2a shows the dental implant carrier 6 with the base body 7 into which the clamping part 9 can be screwed. A funnel-shaped base boy 7 has a plurality of spring-elastic expanding parts 8a and 8d, with the smaller diameter of the base in the installation position being remote from the clamping part 9 or with the peripheral rim with maximum diameter facing the clamping part 9. Expansion slots 12 are arranged between the expanding parts 8a and 8d. The clamping part 9 has a thread 13 for screwing with the base body 7. The widened circular abutment surface 10 can also be recognized which contacts the cover layer of the compacta 3 in the installation position and which thereby enables the axial displacement between the clamping part 9 and the base body 7 in the clamping process. The implant post 9a serves the affixing of the artificial dental implant 11 (FIG. 1f) and is made such that a tool, for example a torque wrench, can be brought into contact therewith for the screwing in of the clamping part 9. In another respect, the implant post 9a shown within the framework of the present invention is only shown schematically. The implant post 9a can also be made conically and can, for example, have a thread, preferably an internal thread. In addition, the implant post 9a can be made such that it can be connected, for example latched, to the clamping part 9 via a releasable affixing device.

FIG. 2b shows the clamping part 2 which can be pre-affixed to the base body 7, which is partly screwed in and which can be inserted in this prefixed state together with the expanding part 7 into a bore 4 of the alveolar bone 1.

FIG. 2c shows a vertical section of the clamping part 9 pre-affixable to the base body 7. In this respect, the clamping parts 8a and 8d can be recognized which are made resiliently with respect to a longitudinal axis 14 of the base body 7—which extends coaxially to the longitudinal axis of the clamping part 9.

FIG. 3a shows the base body 7 with the radially outwardly acting expanding parts 8a and 8b which are made integrally with the base body 7. The base body 7 has at least two regions spaced apart from one another with different diameters D1 and D2, with the base body 7 being made in spring-elastic form in the region of the largest diameter D2 and with the spring load of the base body 7 acting radially outwardly in the region of its largest diameter D2. The expanding parts 8a and 8b are made compressible to a longitudinal axis 7 in the region of the largest diameter D2. In the embodiment shown, the expanding parts 8a and 8b are made compressible to a longitudinal axis 7. In the embodiment shown, the expanding parts 8a to 8d are made as outwardly facing lugs. The angle α measured between the longitudinal axis 14 of the base body 7 and the direction of the outwardly facing lugs is between 10° and 50°, preferably between 20° and 35°.

FIG. 3b shows the base body 7 in a perspective representation with the expansion slots 12 arranged between the expanding parts 8a and 8d. The turned facet at the upper end-face peripheral rim of the expanding parts 8a to 8d can also be recognized in this Figure which prevents a folding together of the base body 7 in the clamping process, in particular on the pressing with the compacta 3. FIG. 3c shows a horizontal section of the base body 7 with the expanding parts 8a to 8d offset by 90° with respect to one another.

FIG. 4a schematically shows the clamping part 9 in a slightly modified embodiment in a side view. In addition to the already described implant post 9a and the widened abutment surface 10, the clamping part 9 in the Figure shown has an additional conical section 15. Due to this conical section 15, the base body 7 or its expanding parts 8a to 8d can additionally be expanded in the radial direction in the clamping procedure so that the expanding parts 8a to 8 are expanded to an increased degree in the bore 4. The external thread of the clamping part 9 is not shown due to the schematic representation. FIG. 4b shows the clamping part 9 in a plan view, with the implant post 9a being made (e.g. a non-circular cross-section) such that it allows the shape-matched reception of a tool for the screwing of the clamping part 9 into the base body 7.

FIG. 5a shows a perspective view of the base body 7 which has six expanding parts 8 (cf. the corresponding cross-section in FIG. 5c) in the embodiment shown there. The expanding parts 8 have a slightly rounded chamfer 20 toward the interior of the base body 7. This results in flattened portions 20 which, as shown in FIG. 5a, form a larger support surface in the direction of the compacta. An improved support of the expanding parts at the compacta is therefore achieved here.

In the embodiment variant in accordance with FIGS. 6a and 6b, chamfered surfaces 22 are arranged at the upper end of the expanding parts 8 which are directed toward the exterior of the base body 7. In this representation, the expanding parts 8 are shown in non-expanded position.

The embodiment in accordance with FIGS. 7a and 7b shows an alternative embodiment of the clamping part 9 which substantially corresponds to the structure of the clamping part 9 explained with respect to FIGS. 4a and 4b. An additional conical section 15 is therefore also formed here. In this embodiment, a cylindrical region which is provided with a row of blades extending in a perpendicular manner adjoins the clamping part 9 above the conical section. This cylindrical blade region 30 thus forms a blade denticulation which ensures an improved fit on the screwing of the implant into the bone.

In the embodiment of the clamping part 9 in accordance with the embodiment of FIGS. 8a and 8b, a cylindrical section blade region is likewise arranged above the conical section 15, with in the embodiment shown here, however, a self-cutting thread 32 being formed which cuts into the compacta and thus enables an intimate connection to the compacta.

The present invention is not limited to the embodiments shown, but includes and covers all the variants and technical equivalents which may fall into the scope of the following claims. The positional indications selected in the description, such as top, bottom, lateral are also related to the customary installation position of the dental implant carrier 6 or to the directly described and represented Figure and are to be transferred to the new position accordingly on a change of position. It is also possible to use the construction of the dental implant carrier 6 in accordance with the invention for other fixings to the human bone system and also to the animal bone system, e.g. as surgical fixation aids in the region of the joints.

1. A dental implant carrier for affixing into a hollow space of a bone, comprising:
a base body insertable into the hollow space, the base body having laterally projecting expanding parts which are made in resilient form;
and a clamping part with an implant post for affixing a dental implant, the clamping part engaging at the base body, wherein the base body is configured to be pulled by the clamping part in a direction of the implant post.

2. A dental implant carrier in accordance with claim 1, wherein the hollow space is a predrilled bore, wherein the base body has at least two regions spaced apart from one another with different diameters in an unloaded state; and wherein that the base body is made in spring-elastic form in a region of a largest diameter of the base body and the spring load of the base body acts radially outwardly in the region of the largest diameter.

3. A dental implant carrier in accordance with claim 2, wherein the base body is made compressible at least in the region of the largest diameter so that it can be inserted into the hollow space from outside.

4. A dental implant carrier in accordance with claim 2, wherein, in an installation position, a smaller diameter of the base body is arranged remote from the dental implant and the largest diameter of the base body is arranged facing the dental implant.

5. A dental implant carrier in accordance with claim 1, wherein the base body has at least one substantially frustoconical outer contour.

6. A dental implant carrier in accordance with claim 1, wherein the base body has at least one expansion slot, between the expanding parts.

7. A dental implant carrier in accordance with claim 1, wherein the base body has at least one thread for screwing to the clamping part.

8. A dental implant carrier in accordance with claim 1, wherein the base body is radially expandable at least regionally by the clamping part.

9. A dental implant carrier in accordance with claim 8, wherein the base body is radially expandable by a conical section arranged or formed at the clamping part.

10. A dental implant carrier in accordance with claim 1, wherein, in an installed state of the dental implant carrier, the base body at least regionally contacts an inner side of an outermost cover layer of the bone.

11. A dental implant carrier in accordance with claim 1, wherein the clamping part has an abutment surface, widened, at least regionally which, in an installed state of the dental implant carrier, contacts an outer side of an outermost cover layer of the bone.

12. A dental implant carrier in accordance with claim 11, wherein a diameter of the abutment surface is larger than a diameter of the hollow space.

13. A dental implant carrier in accordance with claim 1, wherein the expanding parts are expandable by a tensile load exerted onto the base body by the clamping part.

14. A dental implant carrier in accordance with claim 1, wherein the expanding parts are made in resilient form with respect to a longitudinal axis of the base body.

15. A dental implant carrier in accordance with claim 1, wherein the expanding parts are made integral with the base body.

16. A dental implant carrier in accordance with claim 15, wherein the expanding parts have lugs facing outwardly from the longitudinal axis of the base body.

17. A dental implant carrier in accordance with claim 16, wherein a direction of the lugs—with respect to the longitudinal axis of the base body—is between 10° and 50°.

18. A dental implant carrier in accordance with claim 1, wherein the expanding parts of the base body have a chamfer in their upper edge region toward an interior of the base body.

19. A dental implant carrier in accordance with claim 1, wherein the expanding parts of the base body each have chamfered flattened portions toward an outer side of the base body.

20. A dental implant carrier in accordance with claim 9, wherein a cylindrical section at which a blade denticulation is formed by formation of webs adjoins above the conical section of the clamping part.

21. A dental implant carrier in accordance with claim 9, wherein the clamping part has a cylindrical section with a self-cutting thread above the conical section.
